(19) United States
(12) Patent Application Publication
(10) Pub. No.: US 2008/0221733 A1
(43) Pub. Date: Sep. 11, 2008

(54) SYSTEM AND METHOD OF LOCATING RELATIVE POSITIONS OF OBJECTS

(75) Inventors: Kirk A. Morrow, Waterford, MI (US); Adam H. Aeschliman, Fenton, MI (US)

Correspondence Address: DICKINSON WRIGHT PLLC, 1901 L. STREET NW, SUITE 800, WASHINGTON, DC, 20036, US

(73) Assignee: KMT Robotic Solutions, Inc., Auburn Hills, MI (US)

(21) Appl. No.: 12/044,240

(22) Filed: Mar. 7, 2008

Related U.S. Application Data
(60) Provisional application No. 60/893,475, filed on Mar. 7, 2007.

(51) Int. Cl. G06F 19/00

(52) U.S. Cl. 700/258

(57) ABSTRACT

An apparatus and method for performing manufacturing operations using position sensing for robotic arms that efficiently and accurately finds the location of a workpiece or features on a workpiece.

### CROSS REFERENCE TO RELATED APPLICATIONS

This application claims the benefit of U.S. Provisional Application No. 60/893,475, filed Mar. 7, 2007, the entire disclosure of the provisional application being considered part of the disclosure of this application and hereby incorporated by reference.

### BACKGROUND OF THE INVENTION

1. Technical Field

The present invention relates to an apparatus and method for determining a position with a robotic assembly before performing a manufacturing operation. More specifically, the present invention is directed to an apparatus and method for quickly and accurately finding the location of a workpiece, a desired position on a workpiece, or the start of a manufacturing operation on the workpiece using an interactive search strategy.

Robotic assemblies are commonly used in manufacturing to perform a variety of operations including welding, cutting, trimming, drilling, and other shaping and manufacturing operations. Robotic assemblies in manufacturing facilities are commonly used with individual work cells, but also may be arranged along an assembly line. As a workpiece passes down an assembly line or is placed within a robotic work cell, before the robotic assembly performs a manufacturing operation on the workpiece, the robotic assembly must first be calibrated. Typically, the workpiece will be held within a jig or other structure, fixing its dimensions relative to the robotic assembly during the manufacturing operation. The robotic assembly is initially calibrated with a master part placed within the jig and the relevant dimensions of the workpiece, such as position of the workpiece or position of a feature on the workpiece is entered. The locations and dimensions operations to be performed are added to a controller. Of course, any known method of adding a master part or workpiece, dimensions, or operations to be performed to a controller may be used. Once the initial calibration or entry of the master part is completed, the robotic assembly is typically used to perform repetitive manufacturing operations on identical workpieces. The subsequent workpieces being held by a jig or other fixture, travel along an assembly line or are individually placed within the work cell of the robotic assembly. For most robotic assemblies, and in particular for robotic assemblies along assembly lines, such as for welding robots, the workpieces are dimensionally stable and the manufacturing operation may have a large error tolerance, thereby minimizing the frequency of calibration required. For example, once calibrated, a welding robot on a vehicle body assembly line will rarely need recalibration.

For many robots, the only recalibration needed to accurately determine the location of the workpiece to perform a manufacturing operation within the desired manufacturing tolerances is for the robotic assembly to recalibrate by touching a sensor on the assembly such as a sensor on its arm. Once the robotic assembly is recalibrated, typically between a set number of workpieces or before each workpiece, the robotic assembly starts the manufacturing operation.

Some workpieces on which manufacturing operations are performed require a high degree of accuracy in the performed operation, are not dimensionally stable, or may inconsistently vary from an expected position, requiring the robotic assembly to be calibrated to each workpiece, before the start of a manufacturing operation. For workpieces which are not dimensionally stable, during the manufacturing operation, the robotic assembly may need to recalibrate itself to the workpiece between manufacturing steps. Each calibration to a particular workpiece is time consuming, thereby reducing the speed of a manufacturing operation. To adjust for movement of the workpiece relative to the jig or fixture, robotic assemblies use a digital sensor to find an edge feature or similar variation on the workpiece to determine the location of the workpiece. For some parts, two features are found to locate the workpiece. In determining that a workpiece is accurately positioned, or determining the actual location of the workpiece, the robotic assembly checks the position of a specified point or points on the workpiece for any variation relative to the location of the position(s) on the initial calibrating workpiece. With the article or workpiece sufficiently located, and the robot calibrated to the actual workpiece, the robot switches from the sensor to a tool and the manufacturing operation generally proceeds.

Using a digital sensor to find the workpiece or a position on the workpiece is time consuming or at times inaccurate. For example, if the workpiece is substantially shifted within the jig, it may be difficult for the digital sensor to find the desired calibrating feature, such as an edge of the workpiece. Digital sensors generally require a 3-dimensional surface change to identify an edge or feature on the workpiece. Even if the robotic arm eventually finds the workpiece with the digital sensor, the process may be time consuming because the robotic arm has to place the digital sensor at a starting point and then move the sensor a sufficient distance across the feature to detect the sharp 3-dimensional surface change. This moving of the digital sensor to detect a fracture is time consuming as the digital sensor must not only be moved slow enough to ensure an accurate reading of the exact location of the feature but also must be moved for a distance sufficient to account for all variations in location of the workpiece or in particular the feature. Therefore, the sensor start location is set back sufficiently from the expected feature position, so that the location of the workpiece or feature may be found no matter the position within a jig. If further dimensions must be determined before starting a manufacturing operation, repeating the above-described operation to find one or two more features requires valuable time in the manufacturing operation and reduces potential productivity. Therefore, there is a need for a robotic assembly that includes a method of sensing features on a workpiece or the position of a workpiece to perform a manufacturing operation in a more time efficient manner.

Another problem with present known methods of determining workpiece or feature locations is that articles or workpieces such as parts formed from fiberglass, plastic, or other similar materials may not be dimensionally stable while the manufacturing operation is being performed. Therefore, while the time consuming process of locating the workpiece or a feature on the workpiece is performed, the workpiece may shift, move, or shrink. This movement may even occur as the manufacturing operation is performed thereby causing inaccuracies in the manufacturing operation being performed on the workpiece. For example, in performing trimming, cutting, or drilling operations on a fiberglass part such as a large hot tub or boat, the workpiece may shrink during the manufacturing operation. The workpiece may also shrink unpredictably at different rates in different locations on the workpiece. One cause of variable shrinking of a workpiece is the thickness of the material. Some workpieces have a thickness which may randomly vary within a specified range, making the rate of shrinkage difficult to control or predict. For example, a workpiece may have a long extent within a thin thickness, which would have a high rate of shrinkage and a shorter extent with greater thickness, which would have a lower rate of shrinkage. Due to the unpredictability of the shrinkage rates, these variations cannot be accounted for when calibrating the robotic assembly. Therefore, if a large number of holes need to be drilled or extensive cutting operations need to be performed, as the robotic assembly proceeds with its manufacturing operation, the difference between the expected location of operation and actual location may increase, making the workpiece unusable. Therefore, there is a need for a robotic assembly that quickly and accurately finds the workpiece and allows for quick updates during the manufacturing operation to account for workpiece shrinkage as the manufacturing operation is performed.

### SUMMARY OF THE INVENTION

In view of the above, the present invention relates to an apparatus and method for determining a position with a robotic assembly before and during manufacturing operations. More specifically, the present invention is directed to an apparatus and method for quickly and accurately finding the location of a workpiece, a desired position on a workpiece or the start of a manufacturing operation using an interactive search strategy. Furthermore, the present invention also allows for adjustments or updates to the relative position of the workpiece due to movement or shrinkage during the manufacturing operation.

The method generally includes the steps of directing an analog sensor to a first measurement position, based upon an expected location of a first surface of the workpiece. The analog sensor then senses a first surface or feature on the workpiece to determine the actual location of the first surface or feature along at least one axis. With the location of the first surface or feature on a workpiece known, an expected location of a second surface or feature on a workpiece is determined. The system moves the sensor to a second measurement position, based upon the determined second measurement position. The system then senses the actual location of the second surface or feature on the workpiece. The method may further include additional steps for finding additional features or surfaces on the workpiece. The manufacturing operation proceeds once the location of the workpiece, feature, or position of the start of the manufacturing operation is sufficiently determined.

The method may also use a digital sensor in combination with an analog sensor. To ensure maximum efficiency and that a digital sensor does not miss or misinterpret a feature or surface, the analog sensor is used to find the first surface or feature on the workpiece. With the actual location of the first surface or feature determined, the system determines a second measurement position at least in part using the actual determined location of the first surface or feature. The digital sensor may be used in place of the analog sensor subsequent to the first measurement.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 illustrates a schematic of the robotic assembly;

FIG. 2 illustrates a first analog search;

FIG. 3 illustrates a first and second analog search;

FIG. 4 illustrates an analog and digital search;

FIG. 4A illustrates the search patterns on the top surface of the workpiece illustrated in FIG. 4;

FIG. 5 illustrates the use of offset searches;

FIG. 6A illustrates the locations of iterative searches;

FIG. 6B illustrates an exemplary location of first searches on a rotated workpiece;

FIG. 6C illustrates a second iteration of searches on a workpiece;

FIG. 6D illustrates a final iterative search of a workpiece;

FIG. 7A illustrates a search of a workpiece in an expected measurement position;

FIG. 7B illustrates a problematic search with the workpiece offset from the expected position;

FIG. 8 illustrates the shrinkage of an exemplary workpiece;

FIG. 9A illustrates a first exemplary search pattern; and

FIG. 9B illustrates a second exemplary search pattern.

### DETAILED DESCRIPTION OF THE PREFERRED EMBODIMENT

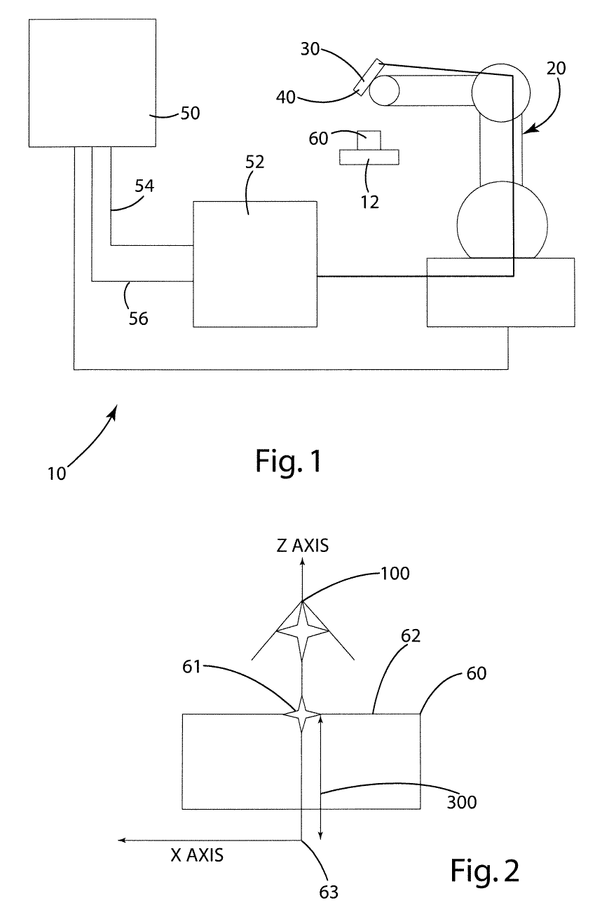

As illustrated in FIG. 1, the present invention is generally directed to a robotic assembly 10 that includes a robotic arm 20, at least one analog sensor 30, a digital sensor 40 and a controller 50 for controlling the movements of the robotic arm 20. The robotic arm 20 is any robotic arm that can position a sensor for measurement, or hold a tool for performing a manufacturing operation.

The robotic arm 20 is illustrated as a six-axis robotic arm, however other configurations of robotic arms may be easily substituted. The size, shape, or configuration of the robotic arm is irrelevant for purposes of the present invention. In some embodiments, a workpiece support assembly 12 may be configured to move in conjunction with the robotic arm 20. Although only a single robotic arm 20 is illustrated in the figures as performing both the functions location of the workpiece and the manufacturing operation, more than one robotic arm, such as a different robotic arm for each task may be used without departing from the scope of the present invention. The robotic arm 20 may further include an end effector (not illustrated) that is capable of selecting different tools and sensors. The robotic arm 20 is controlled by a controller 50 as is well known in the art. The robotic arm controller 50 may also control the sensors 30 and 40, but as illustrated in FIG. 1, the robotic assembly 10 may include a separate sensor controller 52 in communication with the robotic arm controller 50. The sensor controller 52 receives input from the analog and digital sensors 30 and 40 located on or selected by the robotic arm 20. The sensor controller 52 provides an output to the arm controller 50 regarding the actual location of workpiece 60. The sensor controller 52 is illustrated as providing and analog output 54 and a digital output 56 to the controller 50, however these outputs may be combined. Furthermore, the sensor controller 52 may perform all calculations and determinations regarding next position of the robot arm and the surface or feature locations, with the arm controller 50 controlling only the movement of the arm based upon input from the sensor controller. Of course, the arm controller 50 may provide all controls, calculations and determinations, with the sensor controller only turning on and off the sensor and providing raw, complied or processed data from the sensors to the arm controller 50. Any known robot controller or sensor controller may be used to implement the method of the present invention and the actual functions of each may be split in any manner without detracting from the present invention. Also the method may be implemented using any known robotic arm or other robotic device for performing manufacturing operations.

The analog sensor 30 is any analog sensor that has the ability to move with robot arm 20 and be triggered at any desired location. The present invention uses a laser analog sensor, but ultrasonic, infra-red, Doppler, or any other analog sensor capable providing a distance measurement without contacting the workpiece may be used. While some contact analog sensors exist, they have similar drawbacks to the digital sensor and are very time consuming and inefficient to use. Therefore, the present invention only uses non-contact analog sensors. The analog sensor 30 can provide an analog distance measure without contacting the workpiece 20.

The digital sensor 40 can be any digital sensor capable of non-contact measurement providing a digital trigger point when used to search for a feature, such as an edge of the workpiece 20. Examples of digital sensor are laser, ultrasonic, infra-red, Doppler or any other digital sensor providing a digital trigger point regarding a specific desired feature.

The present invention preferably uses one sensor as illustrated in FIG. 1, which combines both the digital and analog sensors 30 and 40 together. In the preferred embodiment, the sensor is a laser sensor that can provide an analog distance output and a digital trigger point regarding specific features. More specifically the sensor provides an analog distance measurement when desired or provides a digital trigger point when desired. These sensors are generally laser measurement devices with dual functionality. Therefore, in operation, the method may provide a single sensor having analog output and digital output. By combining the analog and digital sensors 30 and 40 into a single sensor eliminates the necessity of switching between sensors, which is time consuming and inefficient.

The present invention may use one of two search strategies or a combination thereof for finding the location of workpieces, features on workpieces, or the start of a manufacturing operation on workpieces placed in a robotic work cell or traveling along an assembly line. Exemplary manufacturing operations commonly performed by robotic assemblies include trimming of the workpiece, cutting operations, as well as drilling holes in the workpiece. Of course, the present invention, which includes the method of finding the workpiece, may be used with any robotic assembly that requires an accurate location of the workpiece to perform the desired manufacturing operation. The first method of finding a workpiece uses a plurality of analog searches to locate the workpiece, feature or location of the start of manufacturing operation. The second method of locating a workpiece uses a combination of analog and digital sensors to locate the workpiece, feature, or location of the start of the manufacturing operation. Of course, in some embodiments, the present invention may use a combination of the first and second methods. In performing the methods of locating a workpiece, feature, or start of a manufacturing operation, the present invention may use touch sensors or non-contact sensors, choosing the best suited sensor for a particular measurement.

Before any manufacturing operation may be performed, the robotic assembly must be calibrated. In some embodiments, the calibration to a master workpiece may be entered without any actual measurements by the particular robotic arm, however, most robotic assemblies still use a master workpiece and physically calibrate the robotic assembly to the master workpiece. The purpose of calibration is to both provide the robotic assembly with the details of the expected location of subsequent workpieces as well as where on the workpiece particular manufacturing operations is to be performed. For example, in creating the master workpiece data file which is generally stored in the controller 50, the subject data is loaded into the controller by the robotic arm either learning physically where the workpiece is or being digitally provided with the expected location of the workpiece or features on the workpiece. Any method of providing a calibration of the master workpiece or part may be used to provide the controller 50 with the necessary information to perform the manufacturing operation. The present invention is specifically directed to the finding of the part both before and during the manufacturing operation and is not directed to providing calibration or inputting of the master workpiece data.

Once the robotic assembly is calibrated to a particular workpiece or feature by identifying data at selected measurement points and that data is placed within the controller's memory, subsequent workpieces or features may be found using this data to determine expected locations for measurement. In the first method and as exemplary illustrated in FIG. 2, the robotic assembly directs an analog sensor 30 on the robotic arm 20 to a first measurement position 100 based upon an expected location of the first surface 62 of the workpiece 60. As illustrated in FIG. 2, due to various differences between the workpiece, location of the workpiece within a jig, or even position of the jig, the workpiece may be offset from its expected location. This first offset is illustrated in FIG. 2 as showing the expected location from the master workpiece origin versus the actual location origin of the workpiece being measured. The location of the measured position of the first surface is illustrated by the star 61 along the first surface 62 of the illustrated workpiece 60. The difference between the location on the workpiece illustrated by the star 61 and the master origin 63 is a one dimensional offset 300 and in this case is illustrated as being an offset along the Z-axis as the robotic arm assembly is determining the height or depth of the workpiece 60.

The use of an analog sensor 30 to provide the first search for the workpiece is useful because analog sensor 30 may easily find surface locations of parts without movement of the sensor and without contacting the workpiece. Given the magnitude of offset that may occur between the expected workpiece or feature location and the actual location, digital sensors may be time consuming to find the initial location of the workpiece or may easily miss the workpiece entirely. Therefore, the analog sensor 30 easily finds the workpiece, even if the workpiece is substantially offset.

With the actual location of the first surface or feature 62 of a workpiece along a first axis found, the controller 50 may direct the robotic arm 20 and associated sensor to a second measurement position 102. The second measurement position 102 may be based upon the expected location of the particular feature or master workpiece surface to be measured. However, it is preferable to update the location of the workpiece along the axis already measured within the controller 50 based upon the actual location of the first surface measured from the first measurement position 100. More particularly, the analog sensor 30 in the first measurement position 100 senses the actual location of the first surface of the workpiece 60. Typically the analog sensor 30 may do this without movement for a quick and accurate location of the first surface 62 of the workpiece 60. This sensor output is communicated to a controller which determines the actual location of the first surface 62 of the workpiece 60 including the offset of the actual location from the expected location to determine the one dimensional offset 300 distance along an axis as illustrated in FIG. 2 along the Z-axis. The controller 50 then directs the robotic arm 20 and the analog sensor 30 to a second measurement position 102. By updating the second measurement position 102 based upon the actual location of the first surface 62 of the workpiece 64 or location of a first feature on a workpiece, the sensor is better positioned to obtain a more accurate reading quicker. In some embodiments, without updating the second measurement position 102, the sensor may miss the workpiece entirely.

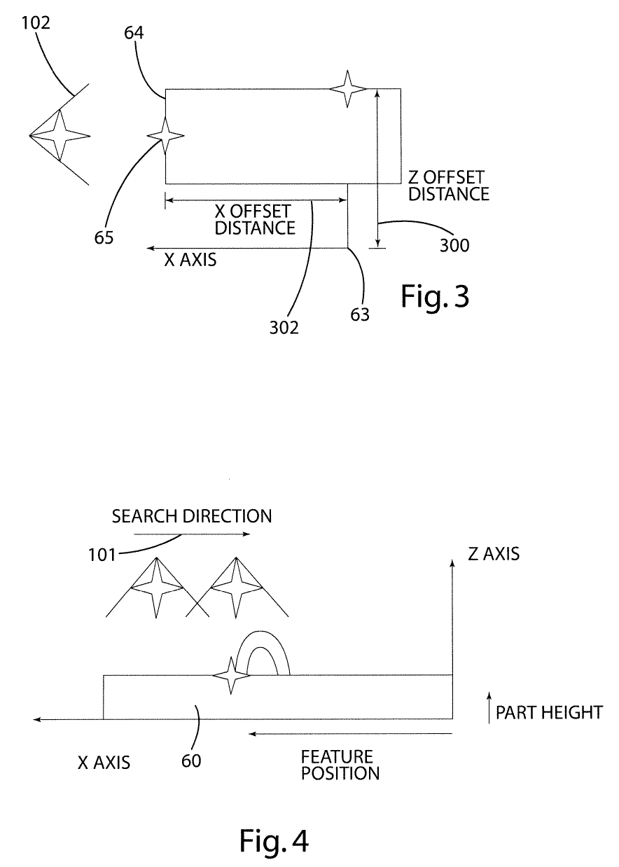

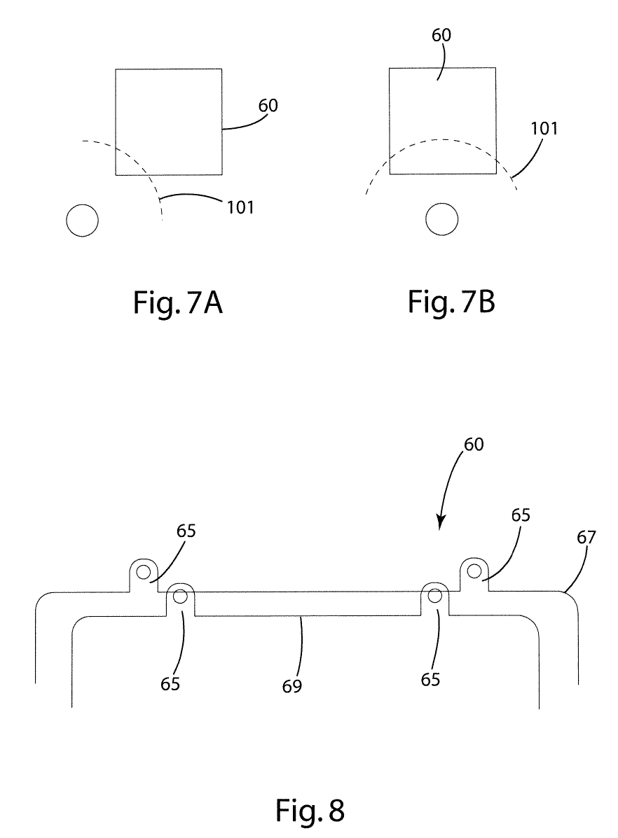

With the analog sensor 30 moved to the second measurement position 102, a second measurement is taken by sensing the actual location of the second surface 64 at the star 65 with the analog sensor 30. The data from the analog sensor 30 output is then provided to the controller, which determines the actual location of the second surface 64 of the workpiece 60 as illustrated in FIG. 3. More specifically, the sensor 30 determines a second offset distance 302 from the expected location based upon the master workpiece origin 63 from the actual location of the second surface 64. In FIG. 3, the second dimensional offset 302 measurement is being illustrated as the offset along the X-axis. With the location along two axes found, in some instances the manufacturing operation may proceed. However, although not illustrated, it may be preferable to repeat the measurement with the analog sensor along a third axis or more to determine the difference between the expected location of a third surface (not shown) of the workpiece 60. Determining additional locations, surfaces or features beyond the above discussed first two measurements provides for greater accuracy in finding the location of the workpiece, feature, or start of a manufacturing operation. In some embodiments, a rotational measurement may also be determined, as illustrated in FIGS. 7A and 7B. FIGS. 7A and 7B further illustrate a sensor sweep path 101 and the problems if the workpiece is misaligned with the robotic arm 20. For example, in 7A, the sweep finds two adjacent edges, but if the workpiece is moved relative to the arm as illustrated in FIG. 7B, the sweep finds two opposing edges. Therefore, once the workpiece is at least partially located along one or two axes, the robotic arm 20 may perform the seep 101, which would provide additional information regarding the rotation of the workpiece or particular features, as well as additional location information.

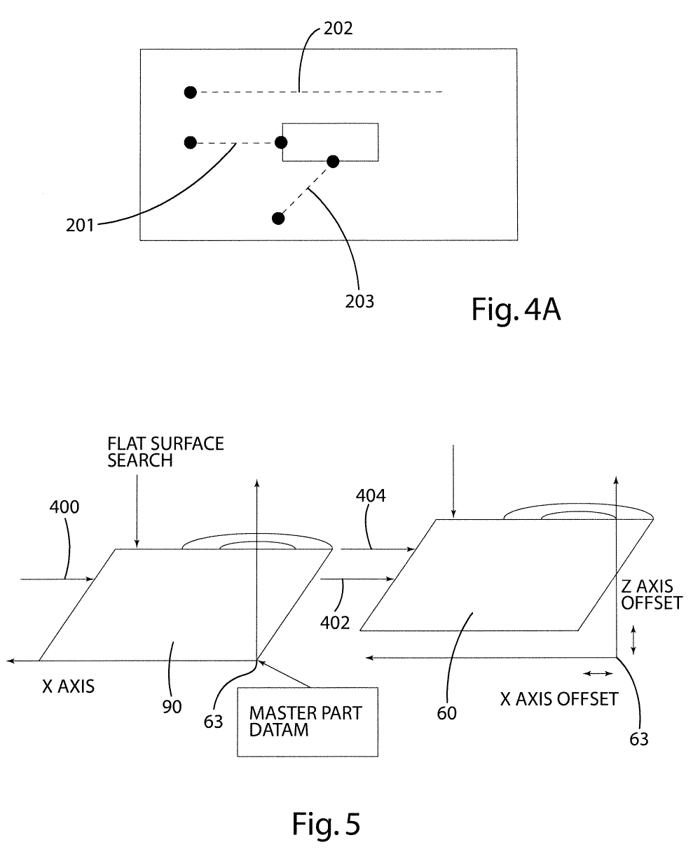

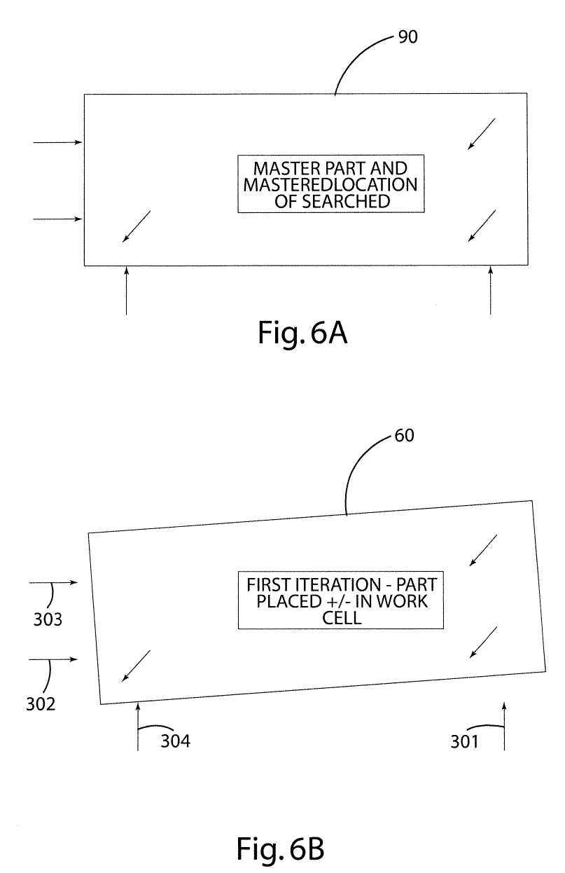

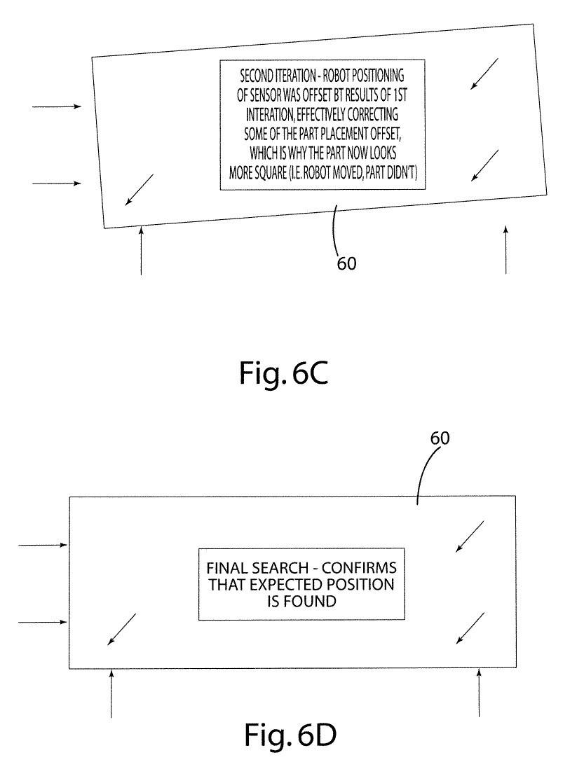

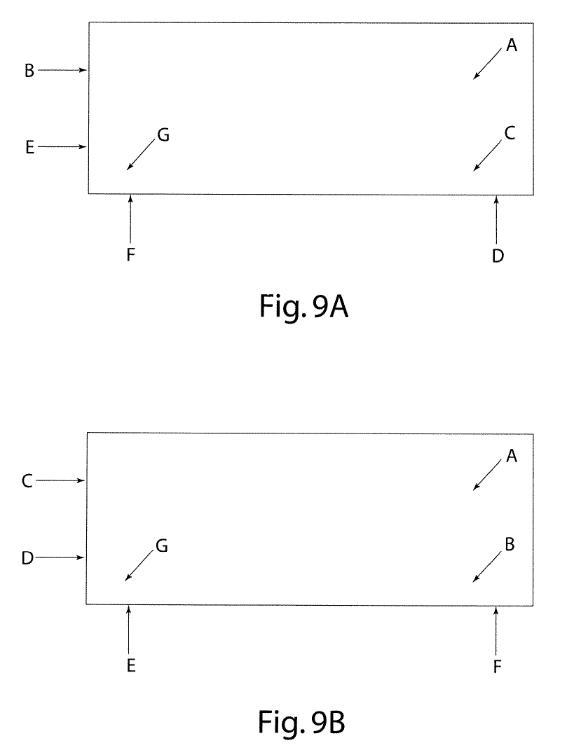

Multiple measurements may also be performed along a particular axis as illustrated in FIGS. 6A-6D. The particular order of a search strategy may vary as illustrated by the exemplary search patterns in FIGS. 9A and 9B. The chosen pattern may depend on the expected location error in placement of a workpiece, such that all measurements are completed on a particular axis or one is completed on each axis to initially locate the workpiece. While the measurements are being shown taken along planar surfaces, various other measurements may be used with the analog sensor to determine the offset distance along a first axis and second axis or the offset along a first, second, and third axis. The searching may be done for only a feature on the workpiece or features on the workpiece such as illustrated in FIGS. 4-5. For example, when a large boat shell is trimmed or holes are drilled for passage of various items such as electrical wiring, fuel lines and supports for cleats, the location for each manufacturing operation must be determined. As a large shell such as a fiberglass hull may vary widely, the robotic assembly may determine the location of a feature of the boat shell near to the expected manufacturing operation. Therefore, instead of locating the complete shell of the boat and performing manufacturing operations based upon the overall location of the shell of the boat, instead smaller features on the boat are found and individual manufacturing operations are performed based upon the location of these features to provide a more accurate result in the manufacturing operation. Furthermore, as the manufacturing operation proceeds, the sensors may be used to update in real time the location of the robotic arm versus the surface and a controller can provide corrections during the manufacturing operation. If the workpiece 60 is shrinking during a manufacturing operation, as illustrated in FIG. 8, the individual updates may allow the system to account for this shrinkage as the manufacturing operations are performed. The workpiece illustrates a first size 67 that shrinks to a second size 69. As further illustrated in FIG. 8, the location of the features 65 move.

As illustrated in FIGS. 6A-6D, measuring many one dimensional or 1D shifts allow the system to define many positions around a workpiece and thereby get an accurate location of the workpiece. The multiple analog search distance readings are useful in finding multiple 1D shift points around a workpiece that does not hold its shape such as it tends to bow or otherwise change shape. By defining the various part locations using these multiple 1D distance measurements, the robots cutting path may be changed to accommodate different shaped workpiece that vary from the master workpiece.

The search strategy may be further improved in the second method by combining a digital sensor with the analog sensor to find features on a workpiece or edges of the workpiece. Digital searches are very useful in finding sharp edges or specific features on a part. The problem with digital searches being very timing consuming to perform is overcome when an analog search is combined with the digital search. Therefore, once the analog search is performed as described above, along at least one dimension, the digital search is performed as the general location of the workpiece is now known. Of course, performing the analog search along multiple dimensions will provide a more accurate location for the digital search to start from thereby in many instances reducing the amount of time required to accurately perform the digital search. Therefore, after performing an analog search as illustrated in FIG. 1 or in FIGS. 2 and 3, the robotic arm assembly may perform a digital search as illustrated in FIG. 4 to find a feature position, or the edge of a part. A feature may be any feature that has a measurable variance such as an eye hole illustrated in FIG. 4. By first providing the general location or an area of a workpiece with analog sensor it is more likely that the digital sensor will quickly find the eye hole or other feature. For example, if a part is both slightly rotated and shifted, the digital sensor may miss the eyelet completely or find it at a wrong location as further illustrated in FIG. 4A. More specifically, the desired search pattern with a digital sensor is illustrated as the dotted line 201. Search 201 is the accurate search that finds the start of the eyelet and by first locating the position of the workpiece, the system ensures that the digital search is efficient and accurate. However, if the workpiece is slightly offset along one of the axes, a search similar to that in dotted line labeled 202 in FIG. 4A may be performed, which would never find the eyelet. If the part is offset and slightly rotated, the dotted line search 203 illustrates finding the wrong position of the eyelet which would cause an inaccurate location for the desired manufacturing operation. After finding a feature location with the digital sensor, the manufacturing operation may be performed.

For small, thin, flat parts that are very consistent in size and shape, finding the three dimensional shape of the part is typically first performed by an analog search, such as to find the top surface and then using the digital sensor to find two edges of the part. If the top surface has any height changes within it, then a digital search may be first performed to find an edge so that the analog search occurs within the right location on the top surface such that the potential for height variations to undesirably effect the analog sensor is minimized.

For many parts it is also preferable to offset searches using data from the other searches to accurately find the location of a surface. For example, when multiple operations are performed to a large workpiece, the location of one feature provides data for the controller to change the location of the first measurement position for the next location to be determined. More specifically, if the workpiece is found to have a large longitudinal shift, the next search will start from an updated first measurement position that takes the longitudinal shift into account. Therefore, each subsequent search for a particular location starts for a more accurate first measurement position thereby each time a search is performed, it occurs more quickly and accurately than the last search. Another example is when a workpiece or feature on a workpiece moves by rotation, it may be difficult to get an accurate search. Furthermore, when a workpiece is tapered such as the workpieces illustrated in FIG. 5, a search to determine the offset along the X-axis may significantly vary. Therefore, as illustrated in FIG. 5, a search is performed in the X direction to find the angled surface to determine the rough location of the part. With the part found, a second search can be performed to find the offset of the flat surface along a second axis such as the Z-axis. Now, with the two searches providing known locations, there is a good reference point to perform a third search along the same axis as the first search to determine the actual location of a particular point on the first surface. As illustrated in FIG. 5, the third search in the offset part is performed relative to the part at the same location as it would be done on the master search. In the illustrated FIG. 5, it is important to note that the first master search 400 along the angled surface in the master workpiece 90 on the left is performed at the same location as the subsequent search 404 relative to the workpiece 60. However, it can be seen relative to the origin 63 that the first workpiece search 402 did occur at the same position as the first master search 400 relative to origin 63.

Further iterative searches may also be performed that provide greater detail and precision and accuracy of finding the workpiece in three dimensions or 3D, yet also accounting for rotation of a workpiece. While a one dimensional rotation of a workpiece may be easy to determine, it is more difficult to determine a two dimensional and three dimensional rotation of a workpiece. Three dimensional rotation of a workpiece is particularly important to objects that vary in shape and size such as a hot tub or boat hull that is shrinking as it is cooling shortly after being formed. Furthermore, large workpieces may also have features that are three dimensionally shifted relative to the overall workpiece such as assembled workpieces and while the workpiece may be easily found, the feature may be needed to be three dimensionally located as well as determine if there is any rotation three dimensionally. More particularly, these workpieces are typically repeatable in size and shape but can not be located repeatably within a work cell. Typically this means placement plus or minus one inch in each axis.

The key to finding a whole workpiece accurately and finding the rotation of the workpiece is to search locations that were searched on the master part. Therefore, as illustrated in FIG. 6A, a master workpiece is placed within the work cell and searched to provide master location data. As further illustrated in FIG. 6B, the actual workpiece is placed within the work cell and a first iteration of searches is performed. The rotation of the workpiece may be seen relative to the robot assembly as it would be viewed in comparison to the master part it is important to note that the arrows have stayed relatively constant while the part has shifted because the robot shifts its view of the part, not that the part actually shifts. Therefore, the search locations are being performed by the robot arm in the precise locations that were used on the master part and the robot may update these positions by moving relative to the part and re-perform the same searches, such that it looks as if the workpiece is moving even if it is not. The large offset of some searches may cause problems in finding the part such as searches labeled 301, 302, 303, and 304. In the second iteration, the robot repositions the sensor based upon the results of the first iteration searches to effectively correct some of the part placement offset. Therefore, in FIG. 6C, the workpiece is illustrated as being relatively more square or more aligned with the master part, i.e., the robot moved to accommodate the shift in the part. Therefore, in the second iteration of the searches, the searches will be performed in a closer proximity to the locations that the searches were performed on the master part. Once the second iteration of searches is performed, the robot may perform additional iterations of search until it is satisfied that the part is accurately located and that the search as performed on the workpiece are performed in almost exactly the same locations as those performed on the master workpiece. FIG. 6D shows a final search that confirms the expected position is found and illustrates the arrows pointing to the search locations as being in the same spot as the original master data. These iterative searches may be used also to find features on a workpiece as well as to find three dimensional shifts of a workpiece. Multiple searches may be performed to first locate the workpiece and then locate the feature. The illustrations in FIGS. 6A-6D are fairly simplistic and the search method does not require the searches to be performed in the location shown and the search locations may be chosen based upon any desired search strategy or number of search locations. As one skilled in the art would recognize, more or less searches may be performed than illustrated in FIGS. 6A-6D. Furthermore, the robot assembly may be satisfied that the workpiece is completely found with only one set of iterative searches.

Therefore, once a part is programmed into a controller the desired searches are programmed and mastered by the controller to create a master data. The master data is stored within the controller. Typically the master data is made inaccessible to the user to insure that the master data does not become corrupt or changed unless specifically desired. Once the controller is prepared with a full set of master data, the next part or workpiece is located into the system for performing a manufacturing operation such as trimming, cutting, or drilling of holes. The appropriate search program is then run in an automatic mode without interaction from the user. The robot assembly performs each of the searches described above as part of the logic program. The differences found from the master position to the next position are calculated into offsets and the offsets are applied as part of the program to be taken into account during manufacturing operations or if necessary to repeat the original part program with a newly located part. The robot assembly then performs the searches iteratively until it is satisfied that the location of the part is found within certain offset parameters. Once the workpiece or part is sufficiently found, the robot assembly starts and performs the manufacturing process.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A method of performing a manufacturing operation on a workpiece using a robotic assembly, said robotic assembly including a robotic arm, at least one analog sensor, and a controller, said method comprising the steps of:
directing the analog sensor on the robotic arm to a first measurement position based upon an expected location of a first surface of the workpiece;
sensing the actual location of the first surface of the workpiece using the analog sensor;
communicating the analog sensor output to the controller to determine the actual location of the first surface of the workpiece;
determining with the controller an expected location of a second surface of the workpiece using the actual location of the first surface of the workpiece;
moving the analog sensor on the robotic arm to a second measurement position, said second measurement position being determined by the expected location of the second surface of the workpiece;
sensing the actual location of the second surface of the workpiece using the analog sensor;
communicating the analog sensor output to the controller to determine the actual location of the second surface of the workpiece; and
determining the location of the start of a manufacturing operation.

2. The method of claim 1, further including after said step of providing the analog sensor output to the controller to determine the actual location of the second surface of the workpiece, the step of determining the expected location of a third surface of the workpiece and moving the analog sensor on the robotic arm to a third measurement position, the third measurement position being determined by the expected location of the third surface.

3. The method of claim 1, further including the step of inputting the expected location of at least two surfaces of a workpiece into the controller, before performing said step of directing the analog sensor on the robotic arm to a first measurement position.

4. The method of claim 1 wherein following said step of sensing the actual location of the first surface of the workpiece using the analog sensor, the controller determines the offset of the actual location of the first surface from an expected location along a first axis.

5. The method of claim 1 wherein following said step of sensing the actual location of the first surface of the workpiece using the analog sensor, the controller determines the offset of the actual location of the first surface from an expected location along the Z-axis.

6. The method of claim 1 wherein following said step of sensing the actual location of the second surface of the workpiece using the analog sensor, the controller determines the offset of the actual location of the second surface along a second axis.

7. The method of claim 1 wherein following said step of sensing the actual location of the second surface of the workpiece using the analog sensor, the controller determines the offset of the actual location of the second surface along the X or Y axis.

8. The method of claim 1 wherein said first and second surfaces provide only the location of a feature on the workpiece and one independent of the exact location of the workpiece.

9. The method of claim 1 further including the step of performing a manufacturing process following said step of determining the location of the start of a manufacturing operation, said robotic arm including a tool for performing said manufacturing process, and wherein said analog sensor provides data to said controller related to multiple surface locations of the workpiece while said manufacturing process is being performed, said controller using said data to adjust the tool to account for deviations from the expected workpiece shape.

10. The method of claim 1 further including the step of performing a cutting operation and wherein said robotic arm includes a cutting tool for performing said cutting operation, said analog sensor sensing the position of an reference surface during the cutting operation and providing position data to the controller during the cutting operation.

11. The method of claim 10 wherein said step of performing a cutting operation further includes the step of adjusting the position of the cutting tool in response to deviations from the expected position of the reference surface.

12. The method of claim 11 wherein said steps of sensing the actual location of the second surface and sensing the actual location of the first surface are performed without moving the analog sensor.

13. The method of claim 1 further including a digital sensor, and wherein said method includes the step of placing the digital sensor at a third measurement position and moving said digital sensor to find an edge on the workpiece, after said step of communicating the analog sensor output to the controller to determine the actual location of the second surface of the workpiece.

14. The method of claim 13 further including the step of using the digital sensor to iteratively measure the location of at least one feature on the workpiece.

15. A method of performing a manufacturing operation on a workpiece using a robotic arm assembly, said robotic assembly including a robotic arm, at least one analog sensor, at least one digital sensor, and a controller, said method comprising the steps of:
directing the analog sensor on the robotic arm to a first measurement position based upon an expected location of a first surface on a workpiece;
sensing the actual location of the first surface of the workpiece using the analog sensor and without substantially moving the analog sensor;
providing the analog sensor output to the controller to determine the actual location of the first surface of the workpiece;
placing the digital sensor at a second measurement position, said second measurement position being determined at least in part by the actual location of the first surface and moving said digital sensor to find an edge on the workpiece; and
sensing the edge of the workpiece with the digital sensor starting from the second measurement position and providing the data from the digital sensor to the controller to determine the actual location of the edge.

16. The method of claim 15, further including the step of placing the digital sensor at a third measurement position, wherein said third measurement position is offset along at least one axis from said second measurement position.

17. The method of claim 16 further including the step of sensing the edge of a workpiece with said digital sensor starting from said third measurement position.

18. The method of claim 17 wherein said step of sensing the edge of a workpiece starting from the third measurement position is performed along a different axis than said step of sensing the edge of a workpiece from said second measurement position.

19. The method of claim 15 further including the step of measuring iteratively the edge of the workpiece from the second measurement position.

20. The method of claim 15 further including the step of measuring iteratively the edge of the workpiece from the locations offset from said second measurement position.

21. The method of claim 16 further including the step of determining a fourth measurement position and using said digital sensor from said fourth measurement position to determine another edge location on said workpiece.

22. The method of claim 21 wherein said first measurement position is along a first axis, said second measurement with said digital sensor determines the offset of an edge of the workpiece along a second axis from an expected edge position.

23. The method of claim 22 wherein said third measurement with said digital sensor determines the offset of an edge of the workpiece along a third axis.

24. The method of claim 22 wherein said third measurement with said digital sensor determines the offset of an edge of the workpiece along the second axis.

25. The method of claim 15 wherein said a third measurement position is determined offset from the second measurement position and measures the same edge as the measured from the second measurement position to determine rotation.

26. The method of claim 15 further including at least one more search along the axis of the first search.

27. The method of claim 15 further including at least one more search along the axis of the second search.

28. The method of claim 15 further including a search along a third axis.

29. The method of claim 28 further including at leas one more search along the third axis.

30. The method of claim 15 further including the step of performing iterative measurements of at least one feature on the workpiece.

31. The method of claim 15 further including the step of performing iterative searches to find the workpiece or feature on the workpiece.

32. The method of claim 15 wherein said robotic assembly does not switch between two different sensors when using said analog sensor and said digital sensor.

33. The method of claim 15 wherein said step of sensing with said analog sensor and said digital sensor are performed with a single sensor that provides both an analog output and a digital output.

34. A method of performing a manufacturing operation on a workpiece using a robotic arm assembly, said robotic assembly including a robotic arm, at least one analog sensor, at least one digital sensor, and a controller, said method comprising the steps of:
directing the digital sensor on the robotic arm to a first measurement position based upon an expected location of a first feature on a workpiece;
sensing the actual location of the first feature using the digital sensor;
providing the digital sensor output to the controller to determine the actual location of the first feature of the workpiece;
placing the analog sensor at a second measurement position, said second measurement position being determined at least in part by the actual location of the first feature;
sensing a second feature on the workpiece with the analog sensor;
providing the analog sensor output to the controller to determine the actual location of the second feature; and
determining the location of the start of a manufacturing operation.

35. The method of claim 34 further including the step of placing the digital sensor at a third measurement position, said third measurement position being determined at least in part by the actual location of at least one of the first and second features, said digital sensor sensing a third feature on the workpiece.

36. The method of claim 34 further including the step of interactively performing searches until the error between expected locations and actual locations is reduced to less than a specified number.
